(19) United States
(12) Patent Application Publication
(10) Pub. No.: US 2006/0040624 A1
(43) Pub. Date: Feb. 23, 2006

(54) Peak power limitation in an amplifier pooling scenario

(76) Inventor: Dietmar Lipka, Berg (DE)

Correspondence Address: ERICSSON INC., 6300 LEGACY DRIVE, M/S EVR C11, PLANO, TX, 75024, US

(21) Appl. No.: 10/536,415

(22) PCT Filed: Dec. 20, 2002
(86) PCT No.: PCT/EP02/14680

§ 371 Date: May 25, 2005

(51) Int. Cl. H04B 1/04; H04L 25/49

(52) U.S. Cl. 455/114.3; 375/297

(57) ABSTRACT

A method and a device for performing peak power limitation are described. A transmitter stage (14) according to the invention comprises a distributing component (18) for distributing the accumulated power of beams or sectors according to a specific distribution scheme among a plurality of power amplifiers (26₁. . . 26₄). The distributing component (18) superimposes two or more digital beam or sector signals to generate combined signals which are individually subjected to peak power limitation. The combined signals are then individually subjected to digital predistortion, converted to analog and upconverted to RF. The upconverted RF signals are individually amplified by the plurality of power amplifiers (26₁ . . . 26₄) constituting a power amplifier pool (26).

### FIELD OF THE INVENTION

The present invention relates to a method and a device for performing peak power limitation. More specifically, the invention relates to performing peak power limitation in a transmitter stage that includes a power amplifier pool with two or more individual power amplifiers.

### BACKGROUND OF THE INVENTION

Wireless cellular communications is continuing to grow unabated. As wireless applications become increasingly widespread, the pressure on network operators to increase the capacity of their networks becomes more intense.

There are a number of ways of enhancing capacity in a wireless cellular network, including frequency hopping, power control, micro cells, and the introduction of adaptive and sector antennas. Adaptive and sector antennas have thus become the subject of increasing interest in recent years.

Unlike conventional cellular antennas, which broadcast energy over an entire cell, adaptive and sector antennas confine the broadcast energy to a narrow beam or a sector. The advantages of directing the broadcast energy into a narrow beam or a sector are increased signal gain, greater range of the signal path, reduced multipath reflection, improved spectral efficiency and increased network capacity.

Several different adaptive antenna architectures can be used for directing energy in the form of a narrow beam toward a mobile device. According to a so-called multibeam or switched-beam approach for example, a particular beam is selected from a set of fixed beams to reach a particular mobile device. According to an alternative approach, a steerable beam is directed toward the mobile device. The main advantage of this latter approach is that beam forming in the downlink direction is not limited to a fixed set of beams or beam shapes. In either case, the direction of the downlink beam is usually derived by estimating the direction of arrival of an uplink beam from the mobile device.

Adaptive and sector antenna solutions require that special care is taken of the power amplifier arrangement in the downlink direction. If for example a separate power amplifier is provided for each beam or sector, the individual power amplifiers have to be designed for the worst case, i.e. the case that all mobile devices are located in a single beam direction or sector. Such a worst case design of the individual power amplifiers makes the amplifiers rather expensive. On the other hand, if the individual power amplifiers are not designed for the worst case the capacity gain resulting from adaptive or sector antennas can not be fully exploited.

In order to avoid the tradeoff between high capacity gain and cost efficient power amplifier design, power amplifier pooling is desirable. By means of power amplifier pooling the accumulated power of a plurality of beams or sectors is distributed among a plurality of power amplifiers according to a specific distribution scheme. If for example the distribution scheme specifies that the accumulated power of all beams or sectors is to be equally distributed among the individual power amplifiers, each power amplifier can be designed for only 1/n of the accumulated power of all beams or sectors, n being the number of beams or sectors.

There is a need for a method and a device for efficiently performing power amplifier pooling in particular in a narrow beam or sectorized environment.

### SUMMARY OF THE INVENTION

As regards a method, this need is satisfied according to the invention by combining power amplifier pooling with peak power limitation. More specifically, the method comprises superimposing two or more digital beam or sector signals to generate combined signals that allow to distribute the accumulated power of beams or sectors according to a specific distribution scheme among the power amplifiers, individually subjecting the combined signals to peak power limitation, and individually amplifying the peak power limitated signals in the power amplifiers.

Thus, the plurality of superimposed digital beam or sector signals included in an individual combined signal may jointly be subjected to peak power limitation. During peak power limitation of an individual combined signal information regarding other combined signals can be taken into account.

Peak power limitation may be performed in the digital domain, e.g. prior to a digital-to-analog conversion. Various mechanisms for peak power limitation can be implemented. As examples, clipping mechanisms or cancellation mechanisms that are based on an estimate of the signal at an input of an individual power amplifier can be mentioned.

The invention may be practiced in a single carrier or in a multiple carrier scenario. In a multicarrier scenario the individual digital beam or sector signals are preferably superimposed carrier-wise, i.e. for each carrier separately. Peak power limitation in the multiple carrier scenario may be performed separately for each individual carrier signal on the basis of parameters that have been generated taking several or all carrier signals into consideration.

According to a preferred variant of the invention, the power distribution is performed in combination with digital predistortion. As regards the signal path of a particular combined signal, the power amplifier output signal can be exploited as feedback signal for the purpose of digital predistortion. However, in principle digital predistortion may be performed in the absence of a feedback signal also. The distribution of the accumulated power of the beams or sectors already in the digital domain enables to apply the inherent advantages of digital predistortion, i.e. compensation of non-linear power amplifier effects, to the individual amplifiers of a power amplifier pool.

The distribution scheme according to which the accumulated power is distributed among the power amplifiers can be predefined or can be selected according to e.g. the current network traffic. Various different distribution schemes can be implemented. According to a first variant of the invention, the distribution scheme specifies that the accumulated power of all beams or sectors is equally distributed among all or a subset of the available power amplifiers. According to a second variant, the distribution scheme specifies a non-equal distribution of the accumulated power among the individual power amplifiers. Such a non-equal distribution is particularly advantageous for e.g. beam forming purposes and allows to use differently designed power amplifiers for the power amplifier pool.

The individual combined signals, which have been generated by superimposing two or more digital beam or sector signals, may be identical or not. Thus, the combined signals may deviate from each other with respect to the superimposed digital beam or sector signals comprised therein. Preferably, however, the same set of digital beam or sector signals is used to generate all combined signals. The generation of the combined signals may include calculating the amplitude and phase weighted sum of all digital beam or sector signals.

Generation of the combined signals can be performed prior to at least one of digital predistortion and peak power limitation. An efficient solution will be to integrate the generation of the combined signals with the weighting and combining that is performed for example in wideband code division multiple access (WCDMA) schemes.

Different technical realizations for distributing the accumulated power among the power amplifiers can be implemented. For example the combined signals may be generated using a dedicated digital coupler matrix. Alternatively or additionally, a digital network for beamforming or sectorshaping can be used. In some cases it might be necessary to extract individual analog beam or sector signals corresponding to the digital beam or sector signals from the output signals of the power amplifiers. To that end, a signal transformer in the form of e.g. an inverse (analog) coupler matrix may be used.

In the case that analog beam or sector signals are to be derived from the power amplifier output signals, and in many other cases, it might be necessary to adjust (e.g. compensate) the relative delays present in the analog domain between e.g. individual upconverted RF signals or the individual power amplifier output signals. Delay control is preferably performed such that in a first step the relative delay between the signals in the analog domain is determined and in a second step the delay is adjusted in the digital domain in accordance with the determined relative delay.

Although the method according to the invention can be performed for various purposes, a preferred variant of the invention relates to performing the method in context with the generation of antenna input signals. Thus, the power amplifier output signals or signals obtained from the power amplifier output signals (like the analog beam signals mentioned above) can be fed to antenna elements that may include one or more individual antenna arrays or sector antennas.

The invention can be implemented as a hardware solution or as a computer program product comprising program code portions for performing the steps of the invention when the computer program product is run on a computing device. The computer program product may be stored on a computer-readable recording medium like a data carrier in fixed association with or removable from the computing device.

As regards the hardware solution, the invention is directed to a transmitter stage for a wireless communications system. The transmitter stage comprises a distributing component for distributing the accumulated power of beams or sectors according to a specific distribution scheme among a plurality of power amplifiers. Additionally, a power amplifier pool and peak power limiting components are provided. The distributing component includes a plurality of signal inputs for digital beam or sector signals and a plurality of signal outputs for combined signals that have been generated by superimposing two or more of the digital beam or sector signals. Individual transmitter units of a transmitter block may be coupled to the outputs of the peak power limiting components and may be configured to perform at least digital-to-analog conversion and RF upconversion. Individual power amplifiers of the power amplifier pool are coupled to the peak power limiting components preferably via the individual transmitter units and amplify the peak power limited signals. Digital predistortion components may be arranged between the signal outputs of the distributing component and the components of the transmitter units that perform digital-to-analog conversion. The digital predistortion components preferably tap the output signal of the associated power amplifiers to obtain a feedback signal.

The transmitter units may be configured as transceiver components, i.e. as components having both a transmitter and a receiver function. The digital predistortion components may be integrated in the transmitter units or may be configured as components separate from the transmitter units.

The transmitter stage may additionally include at least one of a signal transformer for transforming the power amplifier output signals into individual analog beam or sector signals and a delay controller for adjusting relative delays between the individual upconverted RF signals or power amplifier output signals. The distributing component, which may be configured as a digital network for beamforming or sectorshaping or as a digital coupler matrix, is preferably arranged in a signal path after or within a processing unit for generating the digital beam or sector signals, like a baseband spreader unit for spreading the beam or sector signals. Such a spreader unit will for example be required if a WCDMA scheme is to be implemented.

The transmitter stage is advantageously included in an antenna system, e.g. a sectorized antenna system or an adaptive antenna system of the type that has a multibeam or switched-beam architecture or of the type that generates a steerable beam.

### BRIEF DESCRIPTION OF THE DRAWINGS

In the following the invention will be described with reference to exemplary embodiments illustrated in the figures, in which:

FIG. 1 is a schematic block diagram of a first embodiment of an adaptive antenna system according to the invention;

FIG. 2 is a schematic block diagram depicting a single digital predistortion component as used in the adaptive antenna system of FIG. 1; and

FIG. 3 is a schematic block diagram of a second embodiment of an adaptive antenna system according to the invention.

### DETAILED DESCRIPTION OF PREFERRED EMBODIMENTS

In the following description, for purposes of explanation and not limitation, specific details are set forth, such as particular embodiments, circuits, signal formats, etc. in order to provide a thorough understanding of the present invention. It will be apparent to one skilled in the art that the present invention may be practiced in other embodiments that depart from these specified details. In particular, while the different embodiments are described herein below incorporated with a WCDMA adaptive antenna system, the present invention is not limited to such an implementation, but for example can be utilized in any transmission environment that allows amplifier pooling and in particular in combination with a sectorized antenna system. Moreover, those skilled in the art will appreciate that the functions explained herein below may be implemented using individual hardware circuitry, using software functioning in conjunction with a programmed microprocessor or general purpose computer, using an application specific integrated circuit (ASIC), and/or using one or more digital signal processors (DSPs).

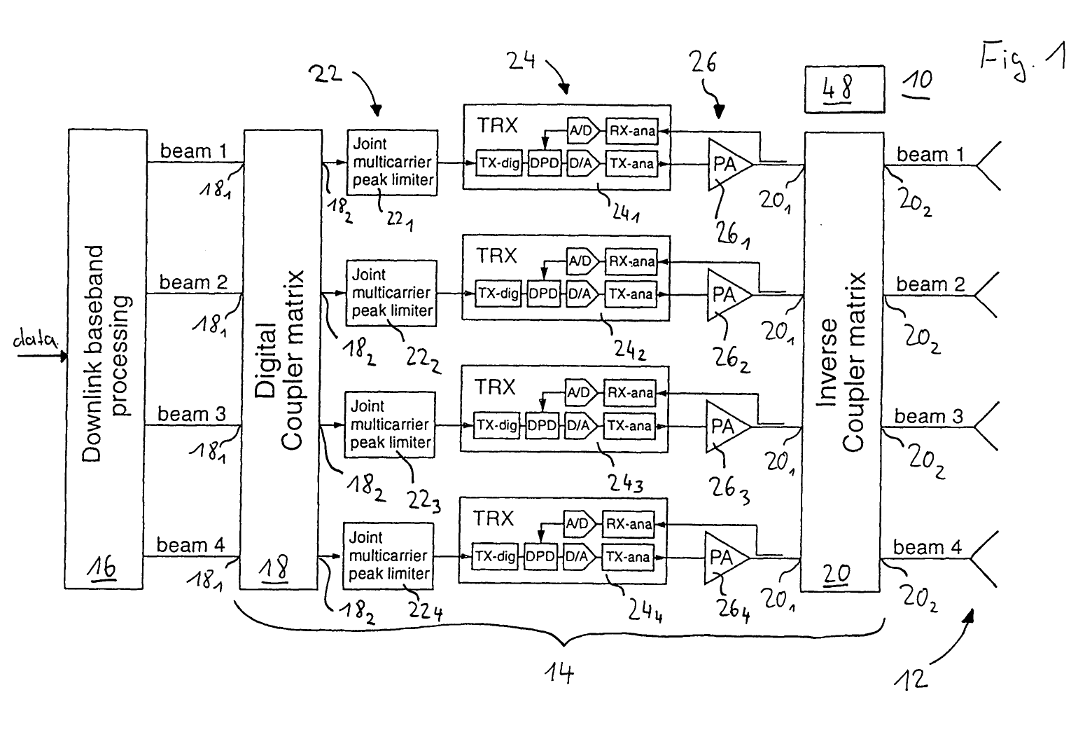

In FIG. 1 a WCDMA adaptive antenna system 10 according to a first embodiment of the present invention is shown. The adaptive antenna system 10 comprises a plurality of antenna elements 12 and a transmitter stage 14 which is coupled to a downlink baseband processing unit 16 on the one hand and the plurality of antenna elements 12 on the other hand. The transmitter stage 14 includes a distributing component in the form of a digital coupler matrix 18 with a plurality of signal inputs 18₁ and a plurality of signal outputs 18₂ as well as an analog signal transformer in the form of an inverse coupler matrix 20 with a plurality of signal inputs 20₁ and a plurality of signal outputs 20₂. A peak power limiting block 22, a transmitter block 24 and a power amplifier pool 26 are arranged between the digital coupler matrix 18 and the inverse coupler matrix 20 of the transmitter stage 14.

The inputs 18₁ of the digital coupler matrix 18 are coupled to the downlink baseband processing unit 16 and the corresponding outputs 18₂ to individual peak power limiting components 22₁ . . . 22₄ of the peak power limiting block 22. Various exemplary mechanisms for performing peak power limitation will be explained in more detail below.

The peak power limiting block 22 is coupled to the transmitter block 24 which includes a plurality of transceiver units 24₁ . . . 24₄. More specifically, each transceiver unit 24₁ . . . 24₄ is coupled via an individual peak power limiting component 22₁ . . . 22₄ to one of the signal outputs 182 of the digital coupler matrix 18.

The power amplifier pool 26 including a plurality of power amplifiers 26₁ . . . 26₄ is arranged in a signal path behind the transmitter block 24. As becomes apparent from FIG. 1, each power amplifier 26₁ . . . 26₄ is associated with an individual transceiver unit 24₁ . . . 24₄.

Outputs of the power amplifiers 26₁ . . . 26₄ are coupled to the inputs 20₁ of the inverse coupler matrix 20. The corresponding outputs 20₂ of the inverse coupler matrix 20 are coupled to the plurality of antenna elements 12.

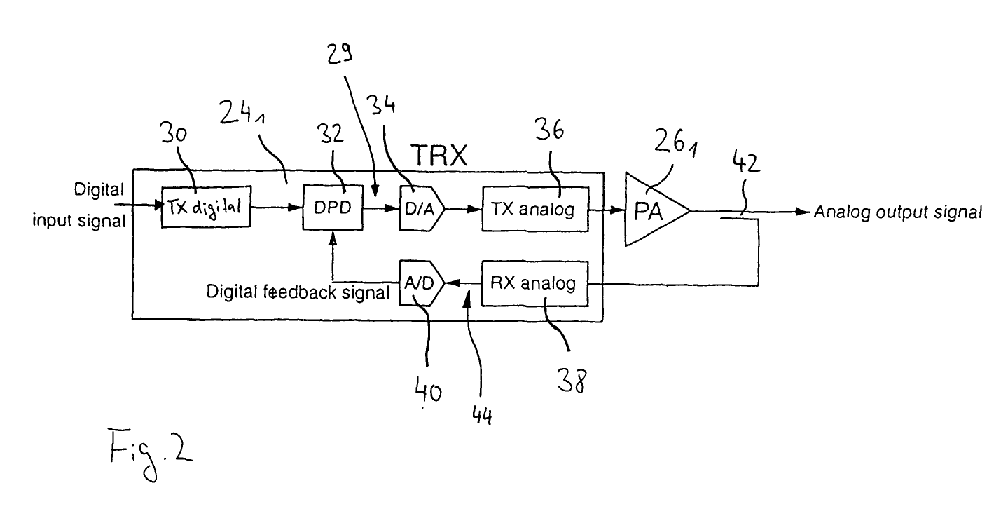

The configuration of a single one of the plurality of transceiver unit/power amplifier combinations shown in FIG. 1 will now be described with reference to FIG. 2. In FIG. 2 the transceiver unit 24₁ and the power amplifier 26₁ of FIG. 1 are depicted. The remaining transceiver units 24₂ . . . 24₄ and power amplifiers 26₂ . . . 26₄ have an identical construction.

From FIG. 2 it can be seen that the transceiver unit 24₁ receives a digital input signal and the power amplifier 26₁ outputs an analog output signal. The transceiver unit 24₁ includes a transmitter branch 29 with a digital transmitter part 30, a digital predistortion component 32 coupled to the output of the digital transmitter part 30, a digital-to-analog converter 34 coupled to the output of the digital predistortion component 32, and an analog transmitter part 36 coupled to the output of the digital-to-analog converter 34. Additionally, the transceiver unit 24₁ includes a receiver branch 44 with an analog receiver part 38 for down-conversion and an analog-to-digital converter 40 coupled to the output of the analog receiver part 38. An output of the analog-to-digital converter 40 is coupled to the digital predistortion unit 32 of the transmitter branch 29.

An input of the power amplifier 26₁ is coupled to an output of the analog transmitter part 36 and an output of the power amplifier 26₁ is coupled via a directional coupler 42 to the input of the analog receiver part 38. The signal path between the directional coupler 42 and the digital predistortion component 32 including the receiver path 44 thus constitutes a feedback path for an output signal of the power amplifier 26₁. The function of this feedback path will be described in more detail below. It should be noted that the digital predistortion component 32 also perform its task without receiving a feedback from the output of the power amplifier 26₁. In such a case the feedback path can thus be omitted.

Now the function of the first embodiment of an adaptive antenna system will be described with reference to FIGS. 1 and 2 in the WCDMA context. WDCMA allows a plurality of different traffic channel signals to be simultaneously transmitted in such a way that they overlap in both the time domain and the frequency domain. In order to distinguish each traffic channel signal from the other traffic channel signals, each traffic channel signal is encoded with one or more unique spreading codes, as is well known in the art. The individual traffic channel signals are then combined into a single, multicode WCDMA signal.

The combination of multiple traffic channel signals into a single WCDMA signal or of independent WCDMA signals into a combined WCDMA signal is performed in the downlink baseband processing unit 16. From user or control data input into the downlink baseband processing unit 16 a plurality of complex baseband beam signals including an in-phase component and a quadrature component are generated. In the exemplary embodiment depicted in FIG. 1, a plurality of four different digital baseband beam signals (beam 1, beam 2, beam 3 and beam 4) that are to be individually transmitted via the four antenna elements 12 is generated. Generation of each digital beam signal includes encoding, interleaving, baseband modulation, channel spreading using a binary channel code sequence, channel weighting, channel combination, and multiplication with a complex scramble code.

The four digital beam signals output by the downlink baseband processing unit 16 are input to the digital coupler matrix 18 via the individual coupler matrix inputs 18₁. In the exemplary embodiment depicted in FIG. 1 there is a separate input 18₁ provided for each of the four digital beam signals.

The digital coupler matrix 18 generates a combined signal by calculating the phase weighted sum of the four digital beam signals. In other words, the individual digital beam signals are superimposed in a non-correlated manner. The combined signal thus obtained is output via each of the four signal outputs 18₂ of the digital coupler matrix 18. Thus, the total power of all beams is equally distributed among four individual branches shown in FIG. 1. In the following, only the uppermost branch including the peak power limiting component 22₁, the transceiver unit 24₁ and the power amplifier 26₁ will be described in more detail. The remaining three branches have an identical construction and operation.

The combined signal which has been generated in the digital coupler matrix 18 for the purpose of equally distributing the accumulated power of the beams among the power amplifiers 26₁ . . . 26₄ is input into the peak power limitation component 22₁ for performing joint multiple carrier peak limitation. Various limitation mechanisms can be implemented by the peak power limitation component 22₁. For example, the peak power limitation component 22₁ may perform baseband clipping as described in U.S. Pat. No. 6,266,320 B1, herewith incorporated by reference as far as an exemplary baseband clipping scheme Is concerned. During baseband clipping, the combined signal is digitally limited to thereby limit the peak-to-average power ratio. This, in turn, is accomplished by measuring the instantaneous amplitude for the in-phase and quadrature components that make up to the combined signal, deriving a maximum amplitude based on the instantaneous amplitude measurements, and then deriving one or more scaling factors based on the maximum amplitude. The one or more scaling factors are then applied to the in-phase and quadrature components.

An alternative approach for performing peak power limitation that may be implemented by the peak power limitation component 22₁ is described in WO 02/11283, herewith incorporated by reference as far as peak power limitation is concerned. The alternative approach includes estimating the amplitude of the analog RF signal that will be input to the power amplifier 26₁ and, based on the estimation, adjusting within the peak power limitation component 22₁ the amplitude of the combined signal such that the amplitude of the analog RF signal input to the power amplifier 26₁ will remain below a predefined threshold.

Of course, other mechanisms like the clipping approach disclosed in EP 1 217 779 A1, herewith incorporated by reference as far as clipping is concerned, could be used as well by the peak power limitation component 22₁ for peak power limitation purposes.

Due to the fact that the peak power limitation components 22₁ . . . 22₄ are arranged in a signal path behind the digital coupler matrix 18, each individual peak power limitation component 22₁ . . . 22₄ jointly limits a plurality of superimposed digital beam signals. Thus, the high peak-to-average power ratio of WCDMA multiuser signals can efficiently be reduced. From the point of view of reducing the peak-to-average power ratio, the superimposed digital beam signals input into each peak power limiting component 22₁ . . . 22₄ behave like a single WCDMA signal. In the present embodiment reduction of the peak-to-average power ratio is thus not effected by the number of digital beam signals included in a particular combined signal.

This would be different if the superposition of the beam signals was performed in the analog domain, i.e. after the transmitter block 24. In such a case the individual digital beam signals would have to be jointly peak power limited in the same way as described in U.S. Pat. No. 6,266,320 B1 for multiple carriers. However, since the subsequent superposition of the individual beam signals in the analog domain causes the amplitude peaks to regrow, it has been found that joint peak power limitation is limited to approximately four beam signals. Such a limitation does not exist in the embodiment depicted in FIG. 1, i.e. if the individual beam signals are superimposed in the digital domain prior peak power limitation.

The combined signal that has been peak power limited in the peak power limitation component 22₁ is fed as digital input signal to the transceiver unit 24₁. As can be seen from FIG. 2, the combined signal is first processed within the digital transmitter part 30. The processed signal output by the digital transmitter part 30 is input to the digital predistortion component 32 which adjusts the combined signal in such a way that non-linear effects of the power amplifier 26₁ are compensated. Thus, the power amplifier efficiency is increased.

In the present embodiment the output signal of the power amplifier 26₁ is tapped by the directional coupler 42 and a signal is fed back via a feedback path to the digital predistortion component 32. The feedback signal is down converted in the analog receiver part 38, converted to the digital domain by the analog-to-digital converter 40 and input to the digital predistortion component 32. By comparing the feedback signal with the combined signal received from the digital transmitter part 30, the predistortion parameters of the digital predistortion component 32 are adapted for an optimal linearisation. As has been mentioned before, digital predestortion could also be performed if no feedback signal was available.

The predistorted combined signal output by the digital predistortion component 32 is converted to analog by the digital-to-analog converter 34 and then upconverted to RF by the analog transmitter part 36. The upconverted RF signal output by the analog transmitter part 36 is input to the power amplifier 26₁.

As can be seen from FIG. 1, the analog output signal of the power amplifier 26₁ is input to the inverse coupler matrix 20 via its signal input 20₁. The inverse coupler matrix 20 also receives the corresponding analog output signals of the remaining three power amplifiers 26₂ . . . 26₄. As has become apparent from the above, the individual analog signals received by the inverse coupler matrix 20 are superpositions of four individual beam signals. The inverse coupler matrix 20 extracts the individual analog beam signals from the power amplifier output signals. The individual analog beam signals are then output by the four signal outputs 20₂ of the inverse coupler matrix 20. Each of the outputs 20₂ is connected to an individual antenna element of the four antenna elements 12. Each antenna element is configured to broadcast the received analog beam signal as a narrow beam in a predefined direction.

Due to imperfections of the analog components of the transmitter stage 14, relative delays between the individual analog signals input to the inverse coupler matrix 20 can occur. Therefore, a digital delay controller 48 is provided which allows to digitally adjust the absolute delay of each of the four branches in such a way that the inverse coupler matrix 20 receives the analog output signals of the power amplifiers 26₁ . . . 26₄ substantially simultaneously. The digital delay controller 48 may be configured as described in EP 1 217 779 A1, herewith incorporated by reference as far as the construction and operation of the digital delay controller 48 is concerned. It should be noted that for clarity reasons the individual control lines associated with the digital delay controller 48 are not shown in FIG. 1.

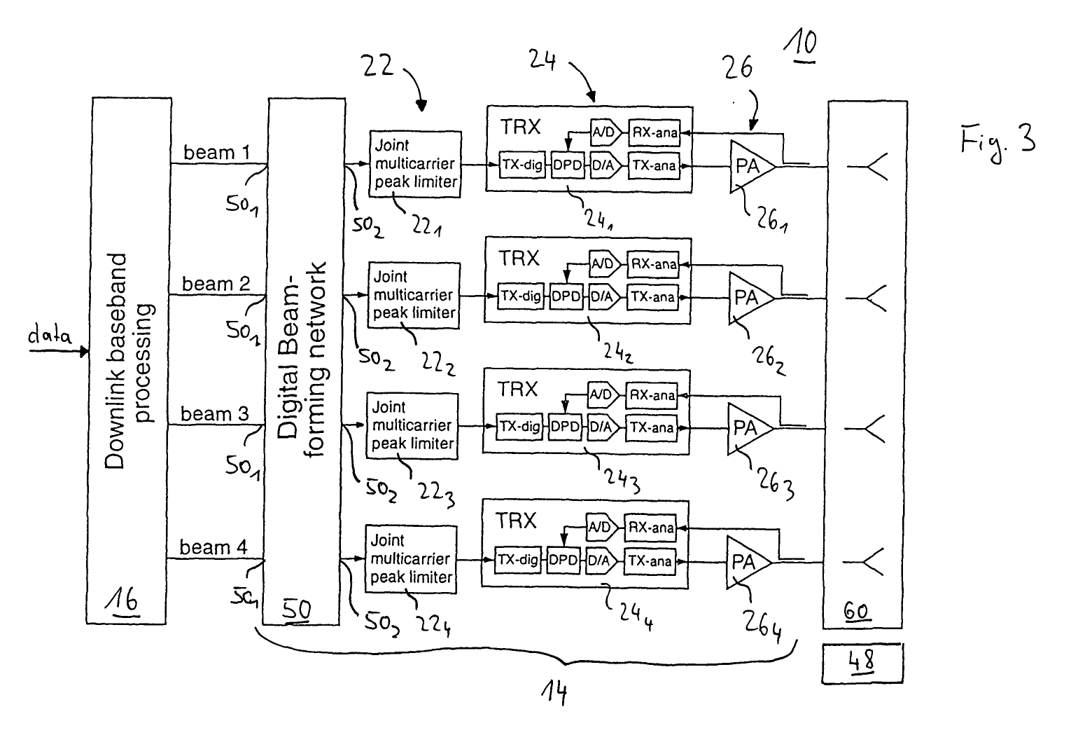

In FIG. 3 a WCDMA adaptive antenna system 10 according to a second embodiment of the present invention is shown. The adaptive antenna system 10 depicted in FIG. 3 has a similar construction and operation like the adaptive antenna system described above with reference to FIGS. 1 and 2. Therefore, only the differences between the two embodiments will be described in more detail hereinafter.

As can be seen from FIG. 3, the digital coupler matrix of the embodiment depicted in FIG. 1 has been substituted by the digital beamforming network 50. The digital beamforming network 50 has a plurality of signal inputs 50₁ and a plurality of signal outputs 50₂. Like the digital coupler matrix of FIG. 1, the digital beamforming network 50 superimposes the four digital beam signals received from the downlink baseband processing unit 16 to generate combined signals.

For beamforming purposes, the combined signals distribute the accumulated power of the beams according to a specific beamforming scheme among the power amplifiers 26₁ . . . 26₄. This means that contrary to the embodiment depicted in FIG. 1, the power of the signals may no longer be equally distributed among the power amplifiers 26₁ . . . 26₄. For sidelobe reduction for example, the power should vary among the individual antenna elements of antenna array 60 in such a way that signals having a lower power are radiated from outer array elements and signals having a higher power from central array elements. A corresponding power distribution scheme is implemented in the digital beamforming network 50. The non-equal power distribution discussed above allows to use smaller amplifiers 26₁, 26₄ for the outer array elements and more powerful amplifiers 26₂, 26₃ for the central array elements.

An advantage of the digital distributing components, i.e. the digital coupler matrix 18 of FIG. 1 and the digital beamforming network 50 of FIG. 3, is the fact that imperfections of processing components in the analog domain can be compensated in the digital domain by e.g. appropriately adapting the coefficients of the digital distributing components. For example phase differences introduced by the transceiver units 24₁ . . . 24₄ may be compensated by controlling the phase of the coefficients or by adding a fixed phase to the digital beam signals.

In the embodiments depicted in FIGS. 1 and 3 the distributing components 18, 50 are located in signal paths behind the downlink baseband processing unit 16. According to an alternative approach not depicted in the drawings, the distributing components 18, 50 could be included in the downlink baseband processing unit 16. An efficient solution would be to integrate the distributing components 18, 50 with the weighting and combiner function of a WCDMA spreader unit included in the downlink processing unit 16.

According to a steered beam approach downlink control of the adaptive antenna systems 10 depicted in FIGS. 1 and 3 may be performed in dependence on the uplink direction from which a signal has been received from a particular mobile device. Moreover, the steered beam approach has the potential to reduce interference on the downlink via nulling, that is, by forming the beam with reduced gain toward interfered co-channel mobile devices. This is especially advantageous in the case of an antenna lobe having a characteristics similar to sin x/x.

While the present invention has been described with respect to particular embodiments, those skilled in the art will recognize that the present invention is not limited to the specific embodiments described and illustrated herein. Therefore, while the present invention has been described in relation to its preferred embodiments, it is to be understood that this disclosure is only illustrative. Accordingly, it is intended that the invention be limited only by the scope of the claims appended hereto.

1-16. (canceled)

17. A method of performing peak power limitation in a transmitter stage that includes a power amplifier pool with two or more power amplifiers, comprising:
superimposing two or more digital beam or sector signals to generate combined signals;
distributing the accumulated power of the beams or sectors according to a specific distribution scheme among the power amplifiers;
individual subjecting the combined signals to peak power limitation in the digital domain prior to conversion to the analog domain; and,
individually amplifying the peak power limited signals in the power.

18. The method of claim 17, further comprising the step of subjecting the combined signals to digital predistortion.

19. The method of claim 17, wherein the combined signals are generated in context with baseband weighting and combining.

20. The method of claim 17, wherein the combined signals are generated by one of a digital network and a digital coupler matrix.

21. The method of claim 17, wherein analog beam or sector signals are derived from the power amplifier output signals.

22. The method of claim 17, further comprising the step of adjusting relative delays between signals that have been converted to the analog domain.

23. The method of claim 17, further comprising the step of utilizing the power amplifier output signals, or signals obtained therefrom, as antenna input signals.

24. A transmitter stage for a wireless communications system, comprising:
a distributing component for distributing the accumulated power of beams or sectors according to a predefined distribution scheme among a plurality of power amplifiers, said distributing component including:
a plurality of signal inputs to receive digital beam or sector signals; and
a plurality of signal outputs to output a combined signal generated by superimposing two or more of the digital beam or sector signals;
peak power limiting components arranged in signal paths behind the signal outputs of the distributing component to limit peak power in the digital domain prior to conversion to the analog domain; and,
a power amplifier pool including individual power amplifiers that are coupled to the peak power limiting components and that amplify the peak power limited signals.

25. The transmitter stage of claim 24, further comprising digital predistortion components arranged between the signal outputs of the distributing component and the digital-to-analog conversion.

26. The transmitter stage of claim 24, wherein the distributing component is configured as one of a digital network and as a digital coupler matrix.

27. The transmitter stage of claim 24, further comprising a signal transformer for transforming the power amplifier output signals into individual analog beam or sector signals.

28. The transmitter stage of claim 24, further comprising a delay controller for adjusting relative delays between analog signals.

29. The transmitter stage of claim 24, wherein the distributing component is arranged in a signal path after or within a spreader unit for spreading the digital beam or sector signals.
